(19) United States
(12) Patent Application Publication
(10) Pub. No.: US 2026/0219054 A1
(43) Pub. Date: Jul. 30, 2026

(54) SYSTEM FOR IMPROVING USER SITUATIONAL AWARENESS DURING VEHICLE INGRESS

(71) Applicant: GM GLOBAL TECHNOLOGY OPERATIONS LLC, Detroit, MI (US)

(72) Inventors: Morgan Andrulis, St. Clair Shores, MI (US); Jacob Alan Bond, Rochester Hills, MI (US)

(73) Assignee: GM GLOBAL TECHNOLOGY OPERATIONS LLC, Detroit, MI (US)

(21) Appl. No.: 19/040,320

(22) Filed: Jan. 29, 2025

(51) Int. Cl. G01C 21/34; G01C 21/36; H04W 4/029; H04W 4/40

(52) U.S. Cl. CPC G01C 21/3461; G01C 21/3614; G01C 21/3617; G01C 21/362; G01C 21/3626; H04W 4/029; H04W 4/40

(57) ABSTRACT

In exemplary embodiments, methods and systems are provided that include one or more sensors of a vehicle and a processor of the vehicle. The one or more sensors are configured to obtain sensor data as to an environment surrounding a user of the vehicle. The processor is coupled to the one or more sensors, and is configured to at least facilitate performing one or more actions for facilitating ingress of the user into the vehicle based on the sensor data; wherein at least one of the one or more actions include providing a notification to the user, via instructions provided by the processors, with relevant information as to the ingress of the user into the vehicle, including based on the environment surrounding the user.

### TECHNICAL FIELD

The technical field generally relates to vehicles and, more specifically, to methods and systems for facilitating ingress toward vehicles, including of passengers with vision impairment and/or other disabilities.

### BACKGROUND

Occupants of vehicles may encounter obstacles or other issues upon ingress toward vehicles in certain situations, including for vehicle occupants that may have visual impairment and/or other disabilities.

Accordingly, it is desirable to provide methods and systems for facilitating situational awareness during vehicle ingress, including for vehicle occupants that may have visual impairment and/or other disabilities.

### SUMMARY

In accordance with an exemplary embodiment, a method is provided that includes obtaining sensor data as to an environment surrounding a user of a vehicle via one or more sensors of the vehicle; and performing one or more actions for facilitating ingress of the user into the vehicle, in accordance with instructions provided by a processor of the vehicle, based on the sensor data; wherein at least one of the one or more actions include providing a notification to the user, via instructions provided by the processor, with relevant information as to the ingress of the user into the vehicle, including based on the environment surrounding the user.

Also in an exemplary embodiment, the notification is provided to an electronic device of the user in accordance with instructions provided by the processor.

Also in an exemplary embodiment, the notification is provided via an emitting of a sound of the vehicle in accordance with instructions provided by the processor.

Also in an exemplary embodiment, the notification is provided via an activation of lights of the vehicle in accordance with instructions provided by the processor.

Also in an exemplary embodiment, the method further includes identifying a closure of the vehicle and means of entry or use for the closure for the user during ingress into the vehicle, via the processor based on the vehicle characteristics and user preferences; wherein the at least one of the one or more actions comprise providing the notification to the user, via instructions provided by the processor, with an identification and location of the closure and means of use or entry for the closure.

Also in an exemplary embodiment, the identification of the closure of the vehicle and means of entry or use for the closure for the user during ingress into the vehicle, via the processor is additionally based on sensor data.

Also in an exemplary embodiment, the method further includes obtaining the location of a personal electronic device of the user relative to the vehicle via wireless communication; and determining, via the processor, a walking route for the user to follow to reach a current location of the vehicle, based on the location of the personal electronic device and map data that is stored in a computer memory of the vehicle.

Also in an exemplary embodiment, the method further comprises determining, via the processor using the sensor data, whether one or more objects in the environment are a threat to the user as the user walks toward the vehicle via the walking route, based on a relative position of the one or more objects with respect to both the user and the walking route; wherein the one or more actions comprise providing information for the user as to the threat.

Also in an exemplary embodiment, the one or more objects are identified by the processor as a threat also based on whether the one or more objects are moving and, if moving, a direction of movement of the one or more objects with respect to both the user and the walking route.

In another exemplary embodiment, a system is provided that includes one or more sensors of a vehicle and a processor of a vehicle. The one or more sensors are configured to obtain sensor data as to an environment surrounding a user of the vehicle. The processor is coupled to the one or more sensors, and is configured to at least facilitate performing one or more actions for facilitating ingress of the user into the vehicle based on the sensor data; wherein at least one of the one or more actions include providing a notification to the user, via instructions provided by the processors, with relevant information as to the ingress of the user into the vehicle, including based on the environment surrounding the user.

Also in an exemplary embodiment, the processor is configured to at least facilitate providing the notification by to an electronic device of the user in accordance with instructions provided by the processor.

Also in an exemplary embodiment, the processor is configured to at least facilitate providing the notification by emitting a sound of the vehicle in accordance with instructions provided by the processor.

Also in an exemplary embodiment, the processor is configured to at least facilitate providing the notification by activating lights of the vehicle in accordance with instructions provided by the processor.

Also in an exemplary embodiment, the processor is configured to at least facilitate identifying a closure of the vehicle and means of entry or use for the closure for the user during ingress into the vehicle, via the processor based on the vehicle characteristics and user preferences; and providing the at least one of the one or more actions by providing the notification to the user, via instructions provided by the processor, with an identification and location of the closure and means of use or entry for the closure.

Also in an exemplary embodiment, the processor is configured to at least facilitate making the identification of the closure of the vehicle and means of entry or use for the closure for the user during ingress into the vehicle, additionally based on sensor data.

Also in an exemplary embodiment, the processor is further configured to at least facilitate obtaining the location of a personal electronic device of the user relative to the vehicle via wireless communication; and determining a walking route for the user to follow to reach a current location of the vehicle, based on the location of the personal electronic device and map data that is stored in a computer memory of the vehicle.

Also in an exemplary embodiment, the processor is further configured to at least facilitate determining, using the sensor data, whether one or more objects in the environment are a threat to the user as the user walks toward the vehicle via the walking route, based on a relative position of the one or more objects with respect to both the user and the walking route; wherein the one or more actions comprise providing information for the user as to the threat.

Also in an exemplary embodiment, the processor is further configured to at least facilitate identifying the one or more objects as a threat also based on whether the one or more objects are moving and, if moving, a direction of movement of the one or more objects with respect to both the user and the walking route.

In another exemplary embodiment, a vehicle is provided that includes a body, a drive system, one or more sensors, a satellite-based location system, and a processor. The drive system is configured to move the body. The one or more sensors are configured to obtain sensor data as to an environment surrounding a user of the vehicle. The satellite-based location system is configured to obtain location data as to a pick-up location at which the user is to ingress into the vehicle. The processor is coupled to the one or more sensors and to the satellite-based location system, and is configured to at least facilitate identifying a door of the vehicle through which the user enters during ingress into the vehicle, based on the sensor data; identifying a means of entry for the door for the user during ingress into the vehicle, based on the sensor data; and performing actions for facilitating ingress of the user into the vehicle based on the sensor data, wherein the actions include providing a notification to the user, via instructions provided by the processors, with relevant information as to the ingress of the user into the vehicle, including based on the environment surrounding the user, including by providing the notification as to the pick-up location in addition to an identification of the door and the means of entry for the door.

Also in an exemplary embodiment, the processor is further configured to at least facilitate providing the notification by to an electronic device of the user in accordance with instructions provided by the processor; emitting a sound of the vehicle in accordance with instructions provided by the processor; and activating lights of the vehicle in accordance with instructions provided by the processor.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle and a remote device, the vehicle having a control system for facilitating situational awareness during vehicle ingress, including for vehicle occupants that may have visual impairment and/or other disabilities, in accordance with exemplary embodiments;

FIG. 2 is a flowchart for a process for facilitating situational awareness during vehicle ingress, including for vehicle occupants that may have visual impairment and/or other disabilities, and that can be implemented in connection with the system of FIG. 1, including the remote device and the vehicle and control system thereof, in accordance with exemplary embodiments; and

FIGS. 3-8 provide depictions of exemplary implementations of the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

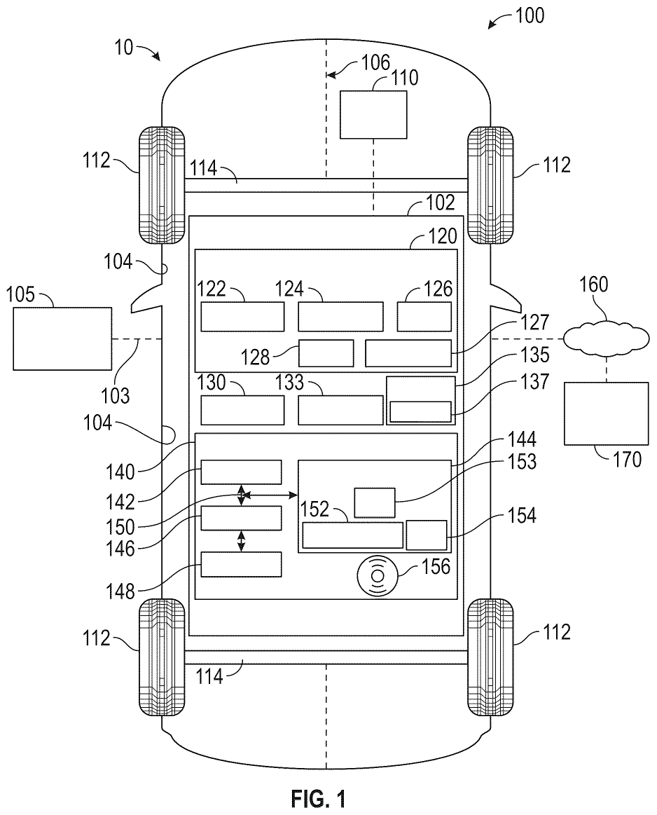

FIG. 1 illustrates a system 10 that includes a vehicle 100 and a remote device 170. As illustrated in FIG. 1, the system 10 further includes one or more wireless communication networks 160 that communicatively couple together the vehicle 100 and the remote device 170. In certain embodiments, the vehicle 100 is representative of a number of different vehicles (e.g., in a fleet) that are likewise coupled to the remote device 170 via the wireless communication networks 160, and that have similar features as those depicted in FIG. 1 and described below in connection with the vehicle 100. Also in various embodiments, the remote device 170 is representative of one or more other vehicles (e.g., for vehicle to vehicle communications), remote servers, and/or infrastructure (e.g., traffic lights, signs, road apparatus, or the like for vehicle to infrastructure communications).

Also as depicted in FIG. 1, in an exemplary embodiment the vehicle 100 is also coupled to a electronic device 105 of a user of the vehicle 100 via one or more wireless connections 103. In certain embodiments, the electronic device 105 comprises a smart phone or related electronic device on an occupant of the vehicle 100. Also in certain embodiments, the vehicle 100 is coupled to the electronic device 105 via a short range wireless network, among other possible wireless connections 103 and/or networks.

In various embodiments, and as described below, the vehicle 100 includes a control system 102 for facilitating situational awareness during vehicle ingress, including for vehicle occupants that may have visual impairment and/or other disabilities.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

In certain embodiments, the vehicle 100 may comprise an autonomous or semi-autonomous vehicle, for example in which vehicle control (including propulsion, steering, braking, and the like) is automatically planned and executed by the control system 102, in whole or in part. In certain other embodiments, the vehicle 100 may also be operated in whole or in part by a human driver.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain embodiments, the drive system 110 provides propulsion in accordance with a driver intent as manifested via the driver's engagement of an accelerator pedal. Also in certain embodiments, the drive system 110 may also provide automatic propulsion control in appropriate circumstances in accordance with instructions provided by the control system 102.

In certain exemplary embodiments, the drive system 110 comprises an internal combustion engine and/or an electric motor/generator, coupled with a transmission thereof. In certain embodiments, the drive system 110 may vary, and/or two or more drive systems 110 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In the embodiment depicted in FIG. 1, the control system 102 is coupled to the drive system 110 as well as to the electronic device 105 and the remote device(s) 170. As noted above, in certain embodiments, the vehicle 100 includes one or more functions controlled automatically via the control system 102, including for facilitating situational awareness during vehicle ingress, including for vehicle occupants that may have visual impairment and/or other disabilities.

As depicted in FIG. 1, in various embodiments, the control system 102 includes a sensor array 120, a location system 130, a transceiver 133, a display system 135, and a controller 140.

In various embodiments, the sensor array 120 includes various sensors that are used for facilitating of ingress of passengers from vehicles. In the depicted embodiment, the sensor array 120 includes one or more cameras 122, other detection sensors 124, input sensors 126, and wireless sensors 127. In various embodiments, the sensor array 120 may also include one or more other sensors 128.

As used herein, the term “passenger” is used to refer to one or more human individuals that are travelling inside the vehicle 100, and who will ingress into the vehicle 100. As used herein, the terms “occupant” and “user” (and/or similar terms) may also be used interchangeably, and with the same meaning, as “passenger”.

In various embodiments, the cameras 122 obtain camera images as to an environment surrounding the vehicle 100, including other vehicles, pedestrians, bicycles, trees, potholes, obstructions, and other objects that may be in proximity to a potential path used by a passenger of the vehicle 100 as he or she ingresses to the vehicle 100.

In certain embodiments, the sensor array 120 also includes one or more other detection sensors 124, instead of or in addition to the cameras 122. In various embodiments, the other detection sensors 124 include one or more radar sensors, Lidar sensors, sonar sensors, or the like, and obtain detection sensor data as to an environment surrounding the vehicle 100, including other vehicles, pedestrians, bicycles, trees, potholes, obstructions, and other objects that may be in proximity to a potential path used by a passenger of the vehicle 100 as he or she ingresses to the vehicle 100.

In various embodiments, the one or more input sensors 126 obtain inputs as to a location of travel for the vehicle and/or the passenger (e.g., including the vehicle to meet the user and the location of the meeting, and so on).

In various embodiments, the wireless sensors 127 include one or more ultra-wide band (UWB) sensors, for example for use in locating individuals (e.g., passengers) who have one or more connected mobile devices (e.g., the electronic device 105).

Also in various embodiments, the sensor array 120 may further include one or more other sensors 128, such as, by way of additional examples, one or more transmission and/or gear sensors of the vehicle 100 (e.g., as to whether the engine is turned on, and/or a current gear of the vehicle 100, and so on), one or more other types of detection sensors, one or more other sensors that measure vehicle parameters such as speed, acceleration, or the like.

Also in various embodiments, the location system 130 is configured to obtain and/or generate data as to a position and/or location in which the vehicle 100 is travelling and/or is about to park. In certain embodiments, the location system 130 comprises and/or is coupled to a satellite-based network and/or system, such as a global positioning system (GPS) and/or other satellite-based system, and/or using a transmission control protocol (TCP) or the like.

In certain embodiments, the vehicle 100 also includes a transceiver 133. In various embodiments, the transceiver 133 communicates with the remote devices 170 via the one or more wireless communication networks 160, along with communication with the electronic device 105 via the wireless connection 103.

In various embodiments, the display system 135 provides information or instructions for one or more passengers of the vehicle 100, including as they ingress toward the vehicle 100. In various embodiments, the display system 135 includes one or more audio components, such as speakers, that provide audible notifications for the passengers. In certain embodiments, the display system 135 may also include one or more other components, such as a visual component (e.g., a display screen), a haptic component (e.g., by shaking a passenger seat or the electronic device 105), or the like.

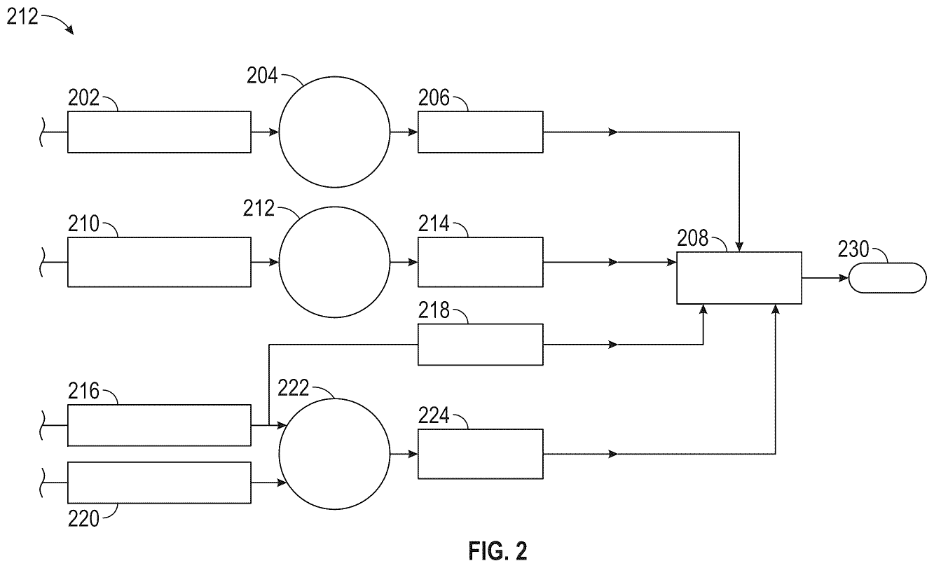

In various embodiments, the controller 140 is coupled to the sensor array 120, the location system 130, the transceiver 133, and the display system 135, as well as to the remote devices 170 and the electronic device 105. In certain embodiments, the control system 102 is also coupled to the drive system 110 and/or to one or more other components of the vehicle 100. Also in various embodiments, the controller 140 comprises a computer system (also referred to herein as computer system 140), and includes a processor 142, a memory 144, an interface 146, a storage device 148, and a computer bus 150. In various embodiments, the controller (or computer system) 140 performs ingress assistance for passengers of the vehicle 100 based on the sensor data obtained from the sensor array 120, and in various embodiments also from the location system 130 and the remote devices 170 (e.g., aerial photographs) via the transceiver 133 and/or via the electronic device 105. In various embodiments, the controller 140 provides these and other functions in accordance with the steps of the processes and implementations depicted in FIGS. 2-8 and as described further below in connection therewith.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 and/or control system 102 and/or one or more components thereof may be disposed outside the body 104, for example on a remote device, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the processes and implementations depicted in FIGS. 2-8 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with map data 153 (e.g., from and/or used in connection with the location system 130 and/or transceiver 133) and one or more stored values 154 (e.g., including, in various embodiments, threshold values).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120, the location system 130, and/or the remote devices 170. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of the processes and implementations of FIGS. 2-8 and as described further below in connection therewith. In another exemplary embodiment, the program product may be directly stored in and/or otherwise accessed by the memory 144 and/or a disk (e.g., disk 156), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With continued reference to FIG. 1, as depicted in FIG. 1 and as described above, in various embodiments the remote device 170 is coupled to the vehicle 100 via the one or more wireless communication networks 160. Similar to the discussion above, in various embodiments, the remote device 170 depicted in FIG. 1 may be representative of one or more different remote devices 170 that comprise and/or are part of and/or coupled to one or more other vehicles (e.g., for vehicle to vehicle communications), remote servers, and/or infrastructure (e.g., traffic lights, signs, road apparatus, or the like for vehicle to infrastructure communications).

In various embodiments, the remote device 170 provides sensor data, such as aerial camera images and/or other information as to the roadway on which the vehicle 100 is travelling, including other vehicles, pedestrians, and/or other objects that may be in the path of or in proximity to the passenger ingresses to the vehicle 100.

Also in various embodiments, the electronic device 105 receives information and instructions from the control system 102 via the transceiver 133, along the wireless connection 103, including instructions for the passenger to travel to the vehicle 100.

FIG. 2 is a flowchart for a process 200 for facilitating situational awareness during vehicle ingress, including for vehicle occupants that may have visual impairment and/or other disabilities, in accordance with an exemplary embodiment. In various embodiments, the process 200 can be implemented in connection with the system 10 of FIG. 1, including the vehicle 100 and the control system 102 thereof, and further including the remote device 170 and the passenger's electronic device 105, in accordance with exemplary embodiments.

As depicted in FIG. 2, the process 200 begins at step 202 in which sensor data is obtained. In various embodiments, sensor data is obtained from the sensor array 120 of the vehicle 100, including as to cameras and other detection sensors thereof. In various embodiments, the sensor data of step 202 is used for obstacle avoidance in step 204 (for example as described in greater detail further below), and notifications of any obstacles or related hazards (step 206). In various embodiments, the notification is provided via instructions provided by the processor 142 to the display system 135 and/or the user's electronic device 105 of FIG. 1. In certain embodiments, one or more other actions may also be taken (step 208), such as automatically moving the vehicle via one or more vehicle systems (e.g., braking, propulsion, and/or steering) in accordance with instructions provided by the processor 142.

In various embodiments, a user location is also obtained (step 210), for example form the GPS location of the user's electronic device 105. In various embodiments, the location data of step 210 includes a geographic location of the user and the vehicle 100 along with a pick-up location at which the user will enter the vehicle 100. In various embodiments, the location information of step 210 is used for vehicle localization in step 212, and notifications of navigation instructions are provided in step 214. In various embodiments, the navigation instructions are provided via instructions provided by the processor 142 to the display system 135 (e.g., emitting a sound such as honking a horn, activating lights via flashing lights or lights of particular, or the like of the vehicle 100) and/or via the user's electronic device 105 of FIG. 1. In certain embodiments, one or more other actions may also be taken (step 208), such as automatically moving the vehicle via one or more vehicle systems (e.g., braking, propulsion, and/or steering) in accordance with instructions provided by the processor 142.

In various embodiments, vehicle identification information is obtained in step 216, such as a vehicle make, model, and the like (e.g., from the memory 144 of the vehicle 100). Also in various embodiments, additional vehicle data is obtained in step 220 (e.g., from the sensor array 120, including cameras 122 and/or other detection sensors), and including as to the vehicle 100's location as well as to obstacles inside or outside of the vehicle 100.

In various embodiments, the vehicle identification information of step 216 and the additional vehicle sensor data of step 220 are utilized for door localization in step 222 (i.e., for locating the door of the vehicle 100 through which the user will enter into the vehicle 100 and/or a trunk, hatch, and/or other door for storing cargo). Also as referenced herein, the terms “door” and “closure” may both refer to any number of doors, trunks, hatches, and/or other types of closure devices, for example that may be used for entering into and exiting from a vehicle, storing cargo, and so on. In various embodiments, notifications are provided to the user as to the vehicle identification (e.g., make, model, and the like) along with navigation instructions for interacting with the door in step 224 (e.g., for how to open and close the door, how to avoid the door if it opens outward, how to climb into the vehicle 100, and so on). In various embodiments, these notifications are provided via instructions provided by the processor 142 to the display system 135 and/or via the user's electronic device 105 of FIG. 1. In certain embodiments, one or more other actions may also be taken (step 208), such as automatically moving the vehicle via one or more vehicle systems (e.g., braking, propulsion, and/or steering) in accordance with instructions provided by the processor 142.

In various embodiments, the process terminates at step 230.

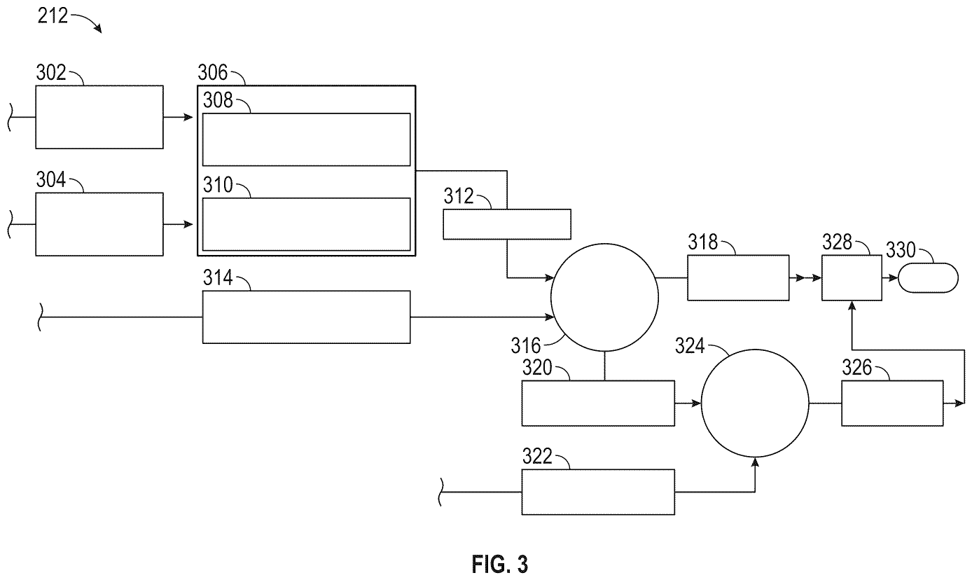

With reference to FIG. 3, an exemplary implementation is provided for step 212 of the process 200 of FIG. 2, namely vehicle localization in accordance with exemplary embodiments.

As depicted in FIG. 3, in exemplary embodiments, determinations are made by the processor as to whether the user is being picked up in a vehicle with which the user is not familiar (step 302) or rather whether the user is finding his or her own vehicle, such as in a parking lot (step 304).

In various embodiments, location information is provided (step 306). Specifically, if the user is being picked up (i.e., step 302), then the current location of the vehicle 100 is provided to the user along with the pickup location (step 308). Conversely, if the user is finding his or her own vehicle in a parking lot (step 304), then only the current location of the vehicle 100 is provided (step 310). In various embodiments, data that has previously been selected (e.g., in step 306) is passed forward at 312, and the user's location is obtained (step 314) (e.g., via the electronic device 105 in certain embodiments).

In various embodiments, navigation information is provided for the user (step 316). In various embodiments, one or more processors provide navigation information for the user to follow to reach the vehicle 100. In certain embodiments, this is performed utilizing the data selection and the user's location information of step 316.

Also in various embodiments, navigation instructions are provided for the user to reach the vehicle 100 (step 318), and a user's proximity to the vehicle 100 is determined (step 320), both based on the navigation information of step 316. In various embodiments, user requests are also obtained (step 322), for example for requesting sounds to be emitted from the vehicle 100 or for a visual signal (e.g., such as flashing the lights, activating lights of a particular, or beeping sounds), and/or in certain embodiments for requesting a pick up location. In various embodiments, the user's proximity of step 320 and the user inputs of step 322 are utilized together by the processor sending the vehicle 100 to the appropriate pick-up location (step 324). Also in various embodiments, vehicle notifications are provided for the user (step 326), for example by activating lights such as by flashing lights or lights of a particular color, emitting a sound such as honking a horn, and the like, in accordance with instructions provided by the processor. In certain embodiments, one or more other actions may be provided (step 328) (e.g., such as unlocking and opening of a door, providing a visual and/or audio indication of the location of the door, and so on). In certain embodiments, the process then terminates at step 330.

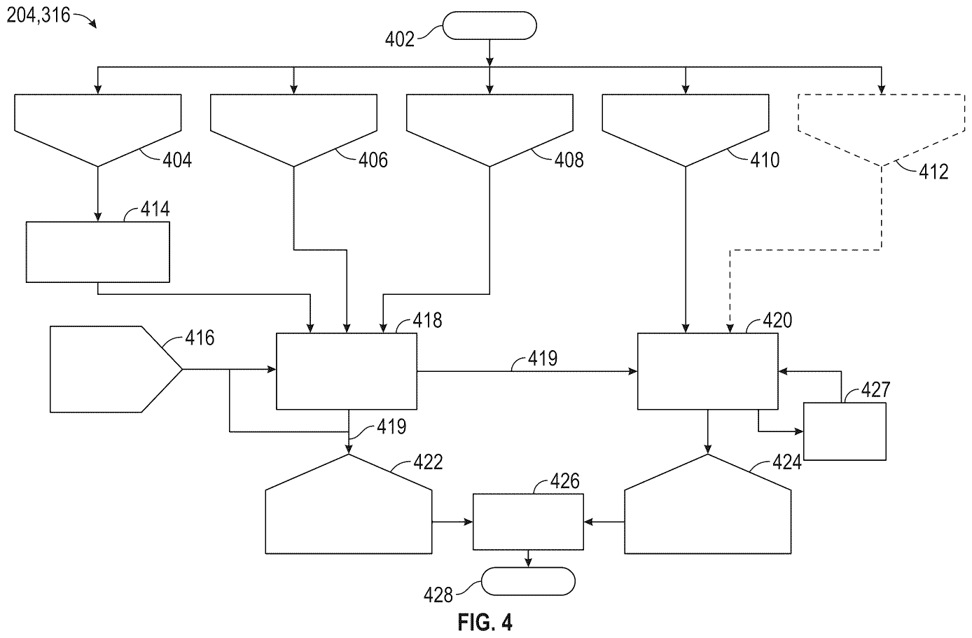

With reference to FIG. 4, a flowchart is provided for an implementation of certain steps of the process 200, including step 204 of FIG. 2 (obstacle avoidance) and step 316 of FIG. 3 (generation of navigation information pertaining to the vehicle 100), in accordance with exemplary embodiments..

As depicted in FIG. 4, in exemplary embodiments, various different types of data are obtained, as represented in steps 404-412 in FIG. 4 and as described below in connection therewith.

In various embodiments, orthoimagery is obtained (step 404). Specifically, in various embodiments, aerial images are obtained as to the vehicle 100 and its surroundings, including the roadway on which the vehicle 100 has been travelling, a parking lot in which the vehicle 100 is parked, and/or other vehicles and/or other objects in proximity thereto. In certain embodiments, the orthoimagery is obtained via one or more remote devices 170 (e.g., via one or more aerial cameras thereof) and is transmitted to the vehicle 100 via the communication network 160 of FIG. 1 (e.g., via vehicle to infrastructure communications in certain embodiments) and then received by the vehicle 100 via the transceiver 133. Also in various embodiments, the orthoimagery comprises graphical information system (GIS) data as to the surroundings of the vehicle 100.

In certain embodiments, the orthoimagery is then pre-processed (step 414), for example by being formatting via the processor 142, such as by image reformatting, image resizing, image stitching, and so on, before the map tiles (orthoimagery) are passed to the next step.

Also in various embodiments, vehicle destination information is obtained (step 406). Specifically, in various embodiments, latitude and longitude values are obtained as to a destination to which the vehicle 100 is travelling, and where the vehicle 100 is to stop (as appropriate) to be picked up by the user. In various embodiments, the vehicle destination information is obtained as inputs from the user (e.g., as sensed via the input sensors 126 of FIG. 1 and/or in certain embodiments via the electronic device 105), and for example in combination with other information that is obtained via the map data 153 stored in the memory 144 of FIG. 1 and location information gathered via the location system 130 of FIG. 1.

Also in various embodiments, user starting location information is obtained (step 408). Specifically, in various embodiments, latitude and longitude values are obtained as to a user starting location. In various embodiments, the user starting location is retrieved from GPS data taken from the electronic device 105 of the user.

In various embodiments, vehicle camera data is also obtained (step 410). Specifically, in various embodiments, camera images are obtained via the cameras 122 of the vehicle 100 as to an environment surrounding the vehicle. In various embodiments, the camera images include the roadway in which the vehicle 100 is travelling, and including a portion of the roadway and/or a parking location in which the vehicle 100 stops upon completion of the vehicle drive, and including the surroundings outside the vehicle 100. In various embodiments, the surroundings include any sidewalks, walkways, curbs, and/or obstacles and/or objects in proximity thereto and/or to the vehicle 100, including without limitation any pedestrians, cyclists, trees, foliage, curbs, posts, stairs, animals, potholes, tripping hazards, and so on.

In certain embodiments, sensor data from one or more other detection sensors 124 of FIG. 1 is also obtained (step 412). Specifically, in various embodiments, detection sensor data is similarly obtained via the other detection sensors 124 of FIG. 1 (e.g., radar sensors, Lidar sensors, sonar sensors, or the like) as to the environment surrounding the vehicle. In various embodiments, the sensor detection data similarly includes detection of the roadway in which the vehicle 100 is travelling, and including a portion of the roadway and/or a parking location in which the vehicle 100 stops upon completion of the vehicle drive, and including the surroundings outside the vehicle 100. In various embodiments, the surroundings include any sidewalks, walkways, curbs, and/or obstacles and/or objects in proximity thereto and/or to the vehicle 100, including without limitation any pedestrians, cyclists, trees, foliage, curbs, posts, stairs, animals, potholes, tripping hazards, and so on.

Also in various embodiments, location data is obtained (step 416). In various embodiments, the location data of step 416 pertains to the location of the user, and is primary obtained via the user's electronic device 105. In certain embodiments, the location data of step 416 may also be corroborated if the vehicle 100 is en-route using the vehicle location, such as by using information from the location system 130 (e.g., a GPS system and/or other navigation system). In various embodiments, latitudinal and longitudinal values are obtained with respect to the passenger (i.e., the user). In certain embodiments, one or more other wireless sensors 127 of FIG. 1 (e.g., ultra-wide band sensors) may also be utilized in this step and/or in other steps of the process 200.

In various embodiments, the passenger is oriented and directed (step 418). Specifically, in various embodiments, once the vehicle 100 reaches its vehicle destination of step 406 (upon completion of the current vehicle drive) and the passenger is about to ingress toward the vehicle 100, the processor 142 of FIG. 1 orients and directs the passenger using the vehicle destination of step 406 as well as the user starting location coordinates of step 408 and the orthoimagery of step 404 and the orthoimagery pre-processing of step 414, and relates these values with location system data from step 416 and map data, including identifying a geographic location, cross streets, and other identifying information as to the surroundings as the passenger exits the vehicle 100.

In various embodiments, as a result of the orientation and directing of step 418, the processor 142 determines a mapped walking route 419 for the user to follow to ultimately reach the vehicle destination/pick up location.

In various embodiments, directions are outputted to the user (step 422). Specifically, in various embodiments, the processor 142 provides instructions for the user as to a specific route of travel for the user to take, while approaching the vehicle 100 at the vehicle destination of step 406, along the mapped walking route 419 beginning at the user starting location of step 408. In certain embodiments, the instructions are outputted to the user via the electronic device 105 of the user as shown in FIG. 1, in accordance with instructions provided by the processor 142 of FIG. 1. Also in certain embodiments, the instructions are also outputted to the user via the display system 135 of FIG. 1 (e.g., including an audio component 137 such as a speaker thereto) also as shown in FIG. 1, in accordance with instructions provided by the processor 142 of FIG. 1.

In addition, in various embodiments, obstacles are detected and localized (step 420). Specifically, in various embodiments, the camera data of step 410 (and in certain embodiments also the detection sensor data of step 412) are utilized to detect any obstacles that may be on or interfere with the user's travelling along the mapped walking route, including without limitation any pedestrians, cyclists, trees, foliage, curbs, posts, stairs, animals, potholes, tripping hazards, and the like. In various embodiments, such detected obstacles are analyzed by the processor 142 as to respective threat levels, including as described below.

Also in various embodiments, obstacle warnings are outputted to the user (step 424). Specifically, in various embodiments, the processor 142 provides warnings for the user as to potential obstacles that should be avoided as the user takes the walking route 419, including without limitation any pedestrians, cyclists, trees, foliage, curbs, posts, stairs, animals, potholes, tripping hazards, and the like, upon exiting the vehicle 100. In certain embodiments, the obstacle warnings are outputted to the user via the electronic device 105 of the user as shown in FIG. 1, in accordance with instructions provided by the processor 142 of FIG. 1. Also in certain embodiments, the obstacle warnings are also outputted to the user via the display system 135 of FIG. 1 (e.g., including an audio component 137 such as a speaker thereto) also as shown in FIG. 1, in accordance with instructions provided by the processor 142 of FIG. 1.

Also in various embodiments, one or more additional actions are taken (step 426). Specifically, in certain embodiments, the processor 142 provides instructions for one or more other vehicle actions to be taken in view of the mapped walking route 419, the directions of step 422, and/or the warnings and/or obstacles of step 424.

In certain embodiments, before the user enters the vehicle 100, the processor 142 takes into account the mapped walking route 419 and/or obstacles detected in step 424, and moves the vehicle 100 to an appropriate stopping location in consideration thereof. For example, in various embodiments, if the vehicle 100 can reach a new stopping location that is closer to the mapped walking route 419 and/or that is easier to access the mapped walking route 419 (e.g., that requires less walking by the user) and/or that avoids a pothole, puddle, or other obstacle detected in step 424, then the processor 142 provides instructions (including to the drive system 110) to move the vehicle 100 to the appropriate location that makes it easier for the user to reach the walking route 419 and further to avoid obstacles, and so on.

Also in various embodiments, during step 427, the processor 142 may also provide instructions for updating the mapped walking route 419, including as conditions change. For example, if the user veers off or away from the mapped walking route, or if other conditions change (e.g., if a new obstacle is present or an existing obstacle changes position or direction, or the like), then in various embodiments the processor 142 updates the walking route 419 accordingly. In various embodiments, steps 418 and 420 are updated accordingly. In certain embodiments, steps 422 and/or 424 may be similarly updated as well.

In various embodiments, the process then terminates at 428 (e.g., when the user reaches the vehicle destination (i.e., the vehicle pick up location).

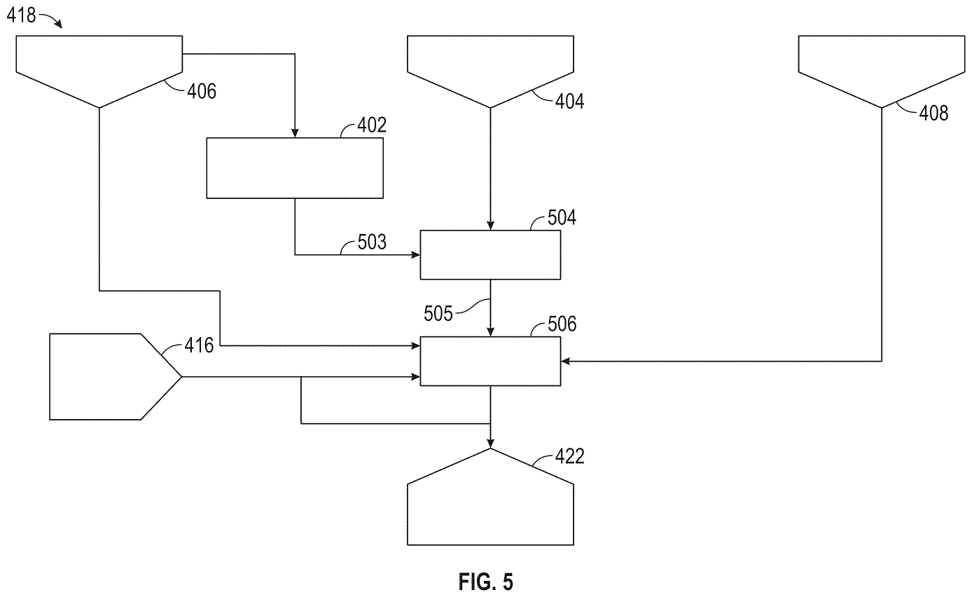

With reference first to FIG. 5, a flowchart of a subroutine representing a step of the sub-process FIG. 4, namely the step of directing and orienting the user (i.e. step 418), in accordance with exemplary embodiments.

As depicted in FIG. 5, in various embodiments, the vehicle destination of step 406, the orthoimagery of step 404, and the user starting location of step 408 are obtained and determined, as described above in connection with FIG. 4.

Also as depicted in FIG. 5, bounding box coordinates are calculated (step 406). Specifically, in certain embodiments, the processor 142 calculates bounding box coordinates for the vehicle destination (including latitude and longitude) of the vehicle destination (e.g., pick-up location)of step 402. As a result, bounding box coordinates 503 (including latitude and longitude) are generated via the processor 142 for the vehicle destination.

Also in various embodiments, detection is performed (step 504). In various embodiments, sidewalks, crosswalks, and/or other user walkways are detected. Specifically, in certain embodiments, bounding box coordinates are used to select which orthoimagery (e.g., map tiles) are needed to cover the vehicle destination area. In various embodiments, the selected tiles are stitched together to form one bigger map tile. Also in various embodiments, sidewalk and crosswalk detection is performed on that map tile, and the sidewalks and crosswalks are segmented from the background of the tile. Also in various embodiments, the sidewalk and crosswalk segmentations are used to form a sidewalk and crosswalk network that is then passed on to the step that maps the walking route.

In various embodiments, the output of step 504 results in a sidewalk network 505 for the environment surrounding the vehicle 100 after the vehicle 100 reaches the vehicle destination of step 406 (and to which the user will enter the vehicle 100).

Also in various embodiments, the location data of step 416 is obtained, as described in greater detail above in connection with FIG. 4. As described above, in various embodiments, the location data of step 416 is obtained from the location system 130 (e.g., a GPS system and/or other navigation system) of FIG. 1 (and/or in certain embodiments the electronic device 105 of FIG. 1) as to the current geographic location of the vehicle 100, including the passenger inside the vehicle 100, and includes latitudinal and longitudinal values are obtained with respect to the vehicle 100 and the passenger.

Also in various embodiments as depicted in FIG. 5, the mapped walking route is determined (step 506). In various embodiments, during step 506, the processor 142 determines the mapped walking route 419 of FIG. 2 for the user to take to reach the vehicle pick up location of step 408 (i.e., to pick up or find the vehicle 100). Specifically, in various embodiments, during step 506, the processor 142 uses the sidewalk network 505 and the location data 416 to determine an optimal mapped walking route 419 for the user to walk to reach the pickup location, the optimal mapped walking route 419 avoids, minimizes, or mitigates the user's encounters with obstacles while also optimizing one or more other criteria for the walking route (e.g., by minimizing time and/or distance, and so on).

In various embodiments, the directions to the destination are then outputted to the user, in accordance with step 422 as described in greater detail above in connection with FIG. 4 (e.g., via the electronic device 105 and/or the audio component 137 of the display system 135 of the vehicle 100 in accordance with instructions provided by the processor 142).

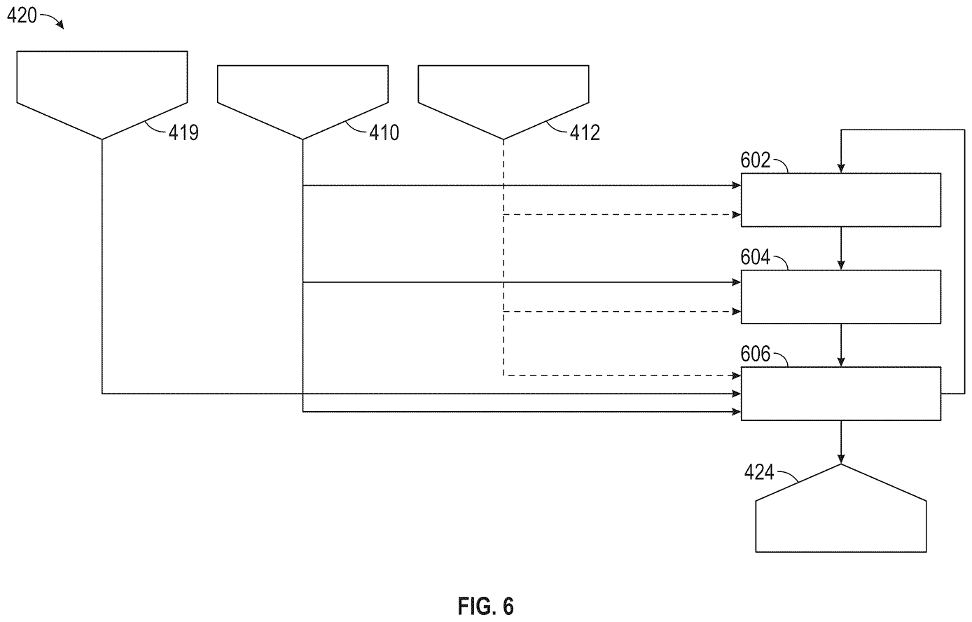

With reference now to FIG. 6, a flowchart is provided of a subroutine representing another step of the process 200, namely the step of detecting and localizing obstacles (step 420) of FIG. 4, in accordance with exemplary embodiments.

As depicted in FIG. 6, in various embodiments, the mapped walking route 419 of FIGS. 4 and 5 is determined, along with the camera data from the vehicle cameras of step 410 and/or the detection sensor data of step 412, also as described above in connection with FIGS. 4 and 5.

Also as depicted in FIG. 6, obstacles are detected (step 602). In various embodiments, one or more obstacles are detected in proximity to the vehicle 100 and/or the walking route 419, in particular obstacles that could potentially contact the user and/or otherwise interfere with the user's ability to use the walking route 419 to reach the vehicle destination (e.g., the vehicle pick-up location). In various embodiments, the obstacles include but are not limited to any nearby pedestrians, cyclists, trees, foliage, curbs, posts, stairs, animals, potholes, tripping hazards, and/or other nearby objects. Also in various embodiments, the obstacles are detected via the cameras 122 of FIG. 1. In addition, in certain embodiments, the obstacles may also be detected in whole or in part by one or more other sensors, such as by way of example one or more other detection sensors 124 of FIG. 1 (e.g., radar sensors, Lidar sensors, sonar sensors, and the like) and/or other sensors 18 of FIG. 1 (e.g., one or more ultra-wide band sensors), or the like.

In various embodiments, the obstacles are localized (step 604). Specifically, in various embodiments, the obstacles that have been detected in step 602 are localized with respect to their relative distances to the vehicle and other objects. In various embodiments, the localization is performed via the processor 142 of FIG. 1 using sensor data from the sensor array 120, such as using cameras, radar sensors, Lidar sensors, and the like, and in certain embodiments may also be supported by ultrawide band (UWB) sensors for those with connected mobile devices. In certain embodiments, other data may also be utilized, for example from the location system 130 (e.g., GPS data), map data 153 stored in the memory 144 of FIG. 1, and/or from one or more remote devices 170, the electronic device 105, and so on.

In various embodiments, threat assessment is performed (step 606). Specifically, in various embodiments, threat assessment is performed with respect to each of the obstacles that have been detected in step 602 and localized in step 604. In various embodiments, the processor 142 analyzes which of the obstacles are likely to contact or interfere with the user as the user utilizes the walking route 419 to reach the ultimate user destination.

In various embodiments, obstacle warnings are provided to the user, in accordance with step 424. As described above in connection with FIG. 4, during step 424 warnings are provided to the user as to the potential obstacles via the display system 135 (e.g., the audio component 137 thereof) and/or the electronic device 105, in accordance with instructions provided by the processor 142. In various embodiments, the warnings are provided as to the specific obstacles that are determined in step 606 to be a threat. In certain embodiments, the warnings include an identification of the object that is determined to be a threat, in addition to recommended actions (e.g., stopping, speeding up, moving a certain direction, and so on) avoid or mitigate the threat from the obstacle.

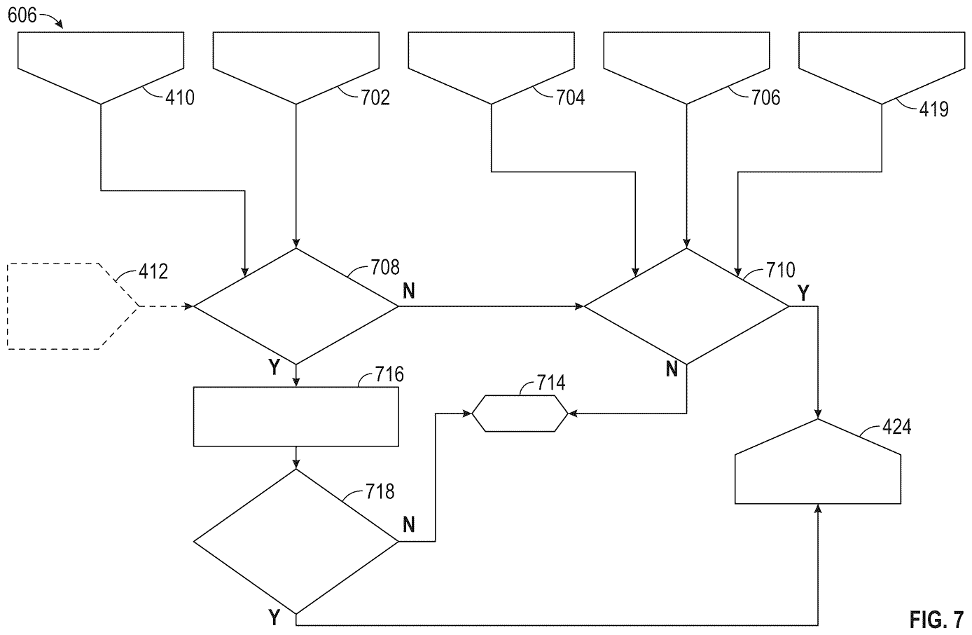

With reference next to FIG. 7, a flowchart is provided of a subroutine representing a step of the subroutine of FIG. 6, namely the step of obstacle threat assessment (step 606), in accordance with exemplary embodiments.

As depicted in FIG. 7, in various embodiments, the mapped walking route 419 of FIGS. 4 and 5 is determined, along with the camera data from the vehicle cameras of step 410, and the detection sensor data of step 412, also as described above in connection with FIGS. 4-6.

In addition, also as depicted in FIG. 7, obstacle distances (step 704) and obstacle positions (step 706) are retrieved. In various embodiments, the obstacle positions and distances may include, among others, relative distances and positions between the obstacles and the user as well as between the obstacles and the walking route 419. Also in various embodiments, these values were obtained in the obstacle localization step.

Also as depicted in FIG. 7, obstacle labels are obtained (step 702). In various embodiments, the labels comprise an identification of the type of the identified obstacle (e.g., motor vehicle, bicycle, tree, and so on) that has been identified. In certain embodiments, the labels may be previously obtained as part of the obstacle detection steps (e.g., via the processor 142 using camera data from the cameras 122, map data 153 stored in the memory 144, and/or via one or more of the remote devices 170 and/or from one or more other sources), and may be utilized in the steps below.

In certain embodiments, a determination is made whether the obstacle is moving (step 708). In various embodiments, this determination is made via the processor 142 using the camera data of step 410 and/or the detection data of step 412, along with the labels generated in step 702, as set forth in FIG. 7.

Also in various embodiments, if it is determined that the obstacle is not moving, then a determination is made as to whether the object is in or near the path of the user (step 710). In various embodiments, these determinations are made by the processor 142 using the mapped walking route 419 along with the obstacle distances of step 704 and the obstacle positions of step 706. In certain embodiments, the obstacle is determined to be near or in the path of the user if obstacle is within a predetermined distance away from the walking route 419.

In various embodiments, if it is determined in step 710 that the obstacle is in or near the path of the user, then the process proceeds to the above-referenced step 424, in which obstacle warnings are provided (e.g., via the electronic device 105 and/or display system 135 of FIG. 1 in accordance with instructions provided by the processor 142 of FIG. 1).

Conversely, in various embodiments, if it is instead determined in step 710 that the obstacle is not in or near the path of the user, then the obstacle is ignored (step 714), as no warning is provided to the user as to this particular obstacle.

With reference back to step 708, if it is instead determined in step 708 that the obstacle is moving, then a dynamic obstacle trajectory prediction is determined (step 716). In various embodiments, the dynamic obstacle trajectory prediction is made by the processor 142 based on the movement of the obstacle.

Also in various embodiments, a determination is made as to whether the obstacle is heading toward or near the user (step 718). In various embodiments, this determination is made by the processor 142 based upon the dynamic obstacle trajectory prediction of step 716. In certain embodiments, the obstacle is determined to be heading toward or near the user if the obstacle is determined to be heading toward the user, and/or if the obstacle is heading toward a portion of the walking route 419 to which the user is also heading.

In various embodiments, if it is determined in step 718 that the obstacle is moving toward or near the user, then the process proceeds to the above-referenced step 424, in which obstacle warnings are provided (e.g., via the electronic device 105 and/or display system 135 of FIG. 1 in accordance with instructions provided by the processor 142 of FIG. 1).

Conversely, in various embodiments, if it is instead determined in step 718 that the obstacle is not moving toward or near the user, then the process proceeds to the above-referenced step 714, as the obstacle is ignored, and no warning is provided to the user as to this particular obstacle.

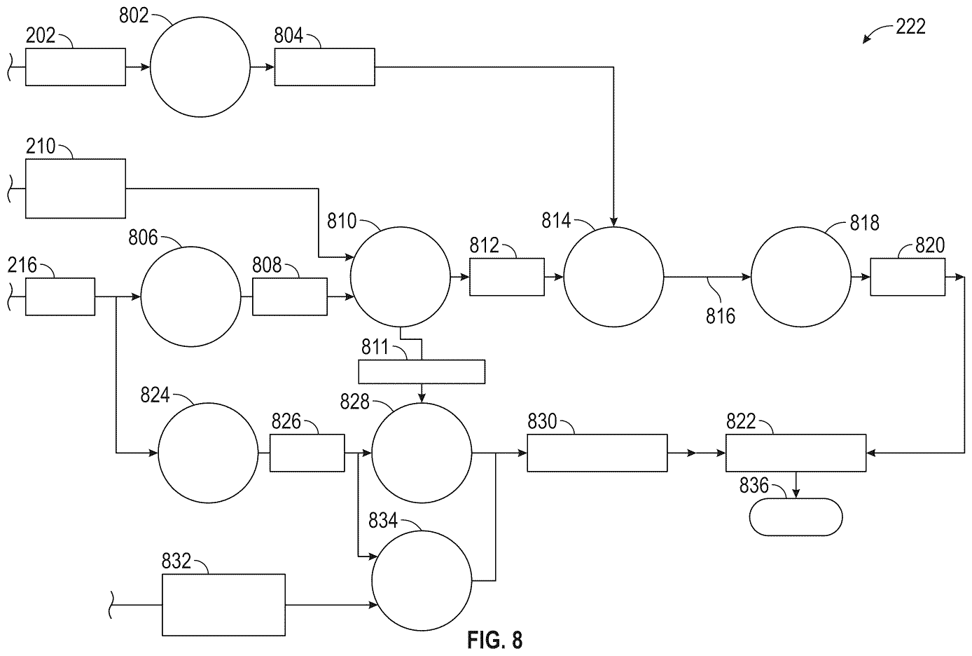

With reference to FIG. 8, a flowchart is provided for an implementation of step 222 of FIG. 2, namely, door localization, in accordance with exemplary embodiments.

As depicted in FIG. 8, in an exemplary embodiment, vehicle sensor data is collected (step 202), along with vehicle location data (step 210), and vehicle identification information (step 216), as previously discussed.

In various embodiments, the vehicle sensor data is utilized by the processor to determine the user's location next to (e.g., relative to) the vehicle 100 (step 802), resulting in user information 804. Also in various embodiments, the vehicle location is utilized by the processor, along with the vehicle identification information, in determining the door location (i.e., of the entry door) of the vehicle 100 (step 806), generating in door location information 808. In various embodiments, an entry door is selected by the processor (step 810) from the vehicle location of step 210 and the door location information 808, generating a selected door 811 and a corresponding entry door location 812.

As depicted in FIG. 8, in exemplary embodiments a calculation is performed as to the user location relative to the selected entry door (step 814), generating a relative user location 816. In various embodiments, the relative user location 816 is utilized by the processor in generating instructions for the user to align with the door (step 818), and instructions are provided at step 818 for instructions for the user to follow to enter the door (e.g., including a direction or movement needed to properly align with an angle of the door, while staying clear of any opening of the door itself and/or any other obstacles, and stepping up, down, and/or other actions for entering the vehicle 100 via the door, and so on). In certain embodiments, one or more other actions may also be taken (step 822), such as automatic movement of the vehicle 100 and/or the door in accordance with instructions provided by the processor for ease of entry of the user through the door, and so on).

With continued reference to FIG. 8, in various embodiments one or more types of doors are identified (step 824) (e.g., based on the vehicle identification information of step 216), generating one or more door types 826 (e.g., sliding door, rotating door, trunk or other cargo door, or the like) and corresponding instructions for opening and entering the selected door (step 828). In various embodiments, in step 824 all door types are retrieved that would be on the specific make and model of the vehicle 100 being used, and in step 828 the entry door ID is used to select the correct door from the list of all door types, and then instructions are generated accordingly. Also in various embodiments, a determination is made as to whether the user needs to store cargo via the door or another door (step 832), for example based on the user inputs. In various embodiments, the processor determines and provides door interaction instructions in step 834 based on the door type 826 and the information of step 832, for example as to opening and using the cargo door (e.g., via instructions provided by the processor to the display system 135 and/or user electronic device 105 of FIG. 1). Also in various embodiments, door interaction instructions are provided for the user for both the entry door and any cargo doors at step 830 (e.g., via instructions provided by the processor to the display system 135 and/or user electronic device 105 of FIG. 1). In certain embodiments, one or more other actions may also be taken (step 822), such as automatic movement of the vehicle 100 and/or the doors in accordance with instructions provided by the processor for ease of entry of the user and/or his or her cargo through the doors, and so on).

Accordingly, methods, systems, and vehicles are provided for facilitating situational awareness for passengers as they ingress toward and into a vehicle.

It will be appreciated that the systems, vehicles, and methods may vary from those depicted in the Figures and described herein. For example, the system 10, including the remote device 170, the vehicle 100 of FIG. 1 and the control system 102 thereof, and/or other components thereof may differ from that depicted in FIG. 1. It will similarly be appreciated that the steps of the processes and implementations of FIGS. 2-8 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method comprising:
obtaining sensor data as to an environment surrounding a user of a vehicle via one or more sensors of the vehicle; and
performing one or more actions for facilitating ingress of the user into the vehicle, in accordance with instructions provided by a processor of the vehicle, based on the sensor data;
wherein at least one of the one or more actions comprise providing a notification to the user, via instructions provided by the processor, with relevant information as to the ingress of the user into the vehicle, including based on the environment surrounding the user.

2. The method of claim 1, wherein the notification is provided to an electronic device of the user in accordance with instructions provided by the processor.

3. The method of claim 1, wherein the notification is provided via an emitting of a sound of the vehicle in accordance with instructions provided by the processor.

4. The method of claim 1, wherein the notification is provided via an activation of lights of the vehicle in accordance with instructions provided by the processor.

5. The method of claim 1, further comprising:
identifying a closure of the vehicle and means of entry or use for the closure for the user during ingress into the vehicle, via the processor based on the vehicle characteristics and user preferences;
wherein the at least one of the one or more actions comprise providing the notification to the user, via instructions provided by the processor, with an identification and location of the closure and means of use or entry for the closure.

6. The method of claim 5, wherein the identification of the closure of the vehicle and means of entry or use for the closure for the user during ingress into the vehicle, via the processor is additionally based on sensor data.

7. The method of claim 1, further comprising:
obtaining the location of a personal electronic device of the user relative to the vehicle via wireless communication; and
determining, via the processor, a walking route for the user to follow to reach a current location of the vehicle, based on the location of the personal electronic device and map data that is stored in a computer memory of the vehicle.

8. The method of claim 7, further comprising:
determining, via the processor using the sensor data, whether one or more objects in the environment are a threat to the user as the user walks toward the vehicle via the walking route, based on a relative position of the one or more objects with respect to both the user and the walking route;
wherein the one or more actions comprise providing information for the user as to the threat.

9. The method of claim 8, wherein the one or more objects are identified by the processor as a threat also based on whether the one or more objects are moving and, if moving, a direction of movement of the one or more objects with respect to both the user and the walking route.

10. A system comprising:
one or more sensors of a vehicle that are configured to obtain sensor data as to an environment surrounding a user of the vehicle; and
a processor that is coupled to the one or more sensors and that is configured to at least facilitate:
performing one or more actions for facilitating ingress of the user into the vehicle based on the sensor data;
wherein at least one of the one or more actions comprise providing a notification to the user, via instructions provided by the processors, with relevant information as to the ingress of the user into the vehicle, including based on the environment surrounding the user.

11. The system of claim 10, wherein the processor is configured to at least facilitate providing the notification by to an electronic device of the user in accordance with instructions provided by the processor.

12. The system of claim 10, wherein the processor is configured to at least facilitate providing the notification by emitting a sound of the vehicle in accordance with instructions provided by the processor.

13. The system of claim 10, wherein the processor is configured to at least facilitate providing the notification by activation of lights of the vehicle in accordance with instructions provided by the processor.

14. The system of claim 10, wherein the processor is further configured to at least facilitate:
identifying a closure of the vehicle and means of entry or use for the closure for the user during ingress into the vehicle, via the processor based on the vehicle characteristics and user preferences; and
providing the at least one of the one or more actions by providing the notification to the user, via instructions provided by the processor, with an identification and location of the closure and means of use or entry for the closure.

15. The system of claim 14, wherein the processor is further configured to at least facilitate making the identification of the closure of the vehicle and means of entry or use for the closure for the user during ingress into the vehicle, additionally based on sensor data.

16. The system of claim 10, wherein the processor is further configured to at least facilitate:
obtaining the location of a personal electronic device of the user relative to the vehicle via wireless communication; and
determining a walking route for the user to follow to reach a current location of the vehicle, based on the location of the personal electronic device and map data that is stored in a computer memory of the vehicle.

17. The system of claim 16, wherein the processor is further configured to at least facilitate:
determining, using the sensor data, whether one or more objects in the environment are a threat to the user as the user walks toward the vehicle via the walking route, based on a relative position of the one or more objects with respect to both the user and the walking route;
wherein the one or more actions comprise providing information for the user as to the threat.

18. The system of claim 17, wherein the processor is further configured to at least facilitate identifying the one or more objects as a threat also based on whether the one or more objects are moving and, if moving, a direction of movement of the one or more objects with respect to both the user and the walking route.

19. A vehicle comprising:
a body;
a drive system configured to move the body;
one or more sensors that are configured to obtain sensor data as to an environment surrounding a user of the vehicle;
a satellite-based location system configured to obtain location data as to a pick-up location at which the user is to ingress into the vehicle; and
a processor that is coupled to the one or more sensors and to the satellite-based location system, the processor configured to at least facilitate:
identifying a door of the vehicle through which the user enters during ingress into the vehicle, based on the sensor data;
identifying a means of entry for the door for the user during ingress into the vehicle, based on the sensor data; and
performing actions for facilitating ingress of the user into the vehicle based on the sensor data, wherein the actions comprise providing a notification to the user, via instructions provided by the processors, with relevant information as to the ingress of the user into the vehicle, including based on the environment surrounding the user, including by providing the notification as to the pick-up location in addition to an identification of the door and the means of entry for the door.

20. The vehicle of claim 19, wherein the processor is further configured to at least facilitate:
providing the notification by to an electronic device of the user in accordance with instructions provided by the processor;
emitting a sound of the vehicle in accordance with instructions provided by the processor; and
activating lights of the vehicle in accordance with instructions provided by the processor.
